(19) United States
(12) Patent Application Publication
(10) Pub. No.: US 2021/0116353 A1
(43) Pub. Date: Apr. 22, 2021

(54) PERMEABILITY MODELING

(71) Applicant: International Business Machines Corporation, Armonk, NY (US)

(72) Inventors: Robert Roy Paar, MIAMI BEACH, FL (US); Kelley Anders, East New Market, MD (US); Jeremy R. Fox, GEORGETOWN, TX (US); Gregory J. Boss, SAGINAW, MI (US)

(21) Appl. No.: 16/656,698

(22) Filed: Oct. 18, 2019

(51) Int. Cl. G01N 15/08; G06F 17/50; G06N 5/04; G06K 9/00; G06K 9/62

(52) U.S. Cl. CPC G01N 15/0806; G06F 17/5009; G06K 9/6261; G06K 9/0063; G06N 5/04

(57) ABSTRACT

A permeability modeling system is provided. An optimal permeability model for, at least, one independent zone based, at least in part, on data associated with the, at least, one independent zone is determined. The optimal permeability model from a plurality of permeability models is determined. one or more predicted geographic images that are associated with, at least, (i) one independent zone and (ii) at least one optimal permeability model is generated.

### BACKGROUND OF THE INVENTION

The present invention relates generally to the field of quantitative analysis, and more particularly to permeability modeling.

Permeability models are often utilized to measure the ability of porous materials to allow fluids to pass through the materials. Additionally, permeability models are utilized to measure the porosity of samples to determine the structure and stability of a plot of land in which construction may occur.

### SUMMARY

Embodiments of the present invention provide a method, system, and program product for managing permeability modeling.

A first embodiment encompasses a method for managing permeability modeling. One or more processors determine an optimal permeability model for, at least, one independent zone based, at least in part, on data associated with the, at least, one independent zone. The one or more processors determine the optimal permeability model from a plurality of permeability models. The one or more processors generate one or more predicted geographic images that are associated with, at least, (i) one independent zone and (ii) at least one optimal permeability model.

A second embodiment encompasses a computer program product for managing permeability modeling. The computer program product includes one or more computer-readable storage media and program instructions stored on the one or more computer-readable storage media. The program instructions include program instructions to determine an optimal permeability model for, at least, one independent zone based, at least, on data associated with the, at 4elast, one independent zone. The program instructions include program instructions to determine the optimal permeability model from a plurality of permeability models. The program instructions include program instructions to generate one or more predicted geographic images that are associated with, at least, (i) one independent zone and (ii) at least on optimal permeability model.

A third embodiment encompasses a computer system for managing permeability modeling. The computer system includes one or more computer processors, one or more computer-readable storage medium, and program instructions stored on the computer-readable storage medium for execution by at least one of the one or more processors. The computer program product includes one or more computer-readable storage media and program instructions stored on the one or more computer-readable storage media. The program instructions include program instructions to determine an optimal permeability model for, at least, one independent zone based, at least, on data associated with the, at 4elast, one independent zone. The program instructions include program instructions to determine the optimal permeability model from a plurality of permeability models. The program instructions include program instructions to generate one or more predicted geographic images that are associated with, at least, (i) one independent zone and (ii) at least on optimal permeability model.

### BRIEF DESCRIPTION OF THE SEVERAL VIEWS OF THE DRAWINGS

FIG. 1 is a functional block diagram illustrating a computing environment, in which a permeability program is executed, in accordance with an exemplary embodiment of the present invention.

FIG. 2 illustrates operational processes of a permeability program generating a geographic representation, on a computing device within the environment of FIG. 1, in accordance with an exemplary embodiment of the present invention.

FIG. 3 illustrates operational processes of a permeability program generating a forecasted image of the geographic representation, on a computing device within the environment of FIG. 1, in accordance with an exemplary embodiment of the present invention.

FIG. 4 depicts a cloud computing environment according to at least one embodiment of the present invention.

FIG. 5 depicts abstraction model layers according to at least on embodiment of the present invention.

FIG. 6 depicts a block diagram of components of one or more computing devices within the computing environment depicted in FIG. 1, in accordance with an exemplary embodiment of the present invention.

### DETAILED DESCRIPTION

Detailed embodiments of the present invention are disclosed herein with reference to the accompanying drawings. It is to be understood that the disclosed embodiments are merely illustrative of potential embodiments of the present invention and may take various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

While possible solutions to generation of permeability modeling-based geographic representations and prediction images based on those geographic representations are known, these solutions may be inadequate to articulate a threshold level of accuracy with the determination of the best-fit permeability model for each geo-fenced zone encompassed by the captured image. Additionally, these known solutions may be inadequate to illustrate an accurate level of determination of a generation of a predicted image based on the geographic representations and the threshold level of accuracy that the correct permeability models are being utilized within the captured image.

In general, permeability model-based geographic representations are generated using sensors to identify and obtain data based, at least in part, on the geographic location of the image contained within the permeability model-based geographic representation. The permeability programs often determine the permeability data and soil data of the geographic location and further determine the permeability model that should be utilized for the (i) geographic representation as a whole or (ii) for each independent zone within the geographic representation, respectively. In general, permeability programs recognize when various permeability models would be more effective for a particular geographic location than other various permeability models based, at least in part, on the permeability data and soil data obtained by the sensors.

Embodiments of the present invention recognize that certain permeability programs may not provide an adequate predicted image to illustrate the rate of erosion. Embodiments provide permeability programs that divide each respective captured image into one or more independent zones and categorize the independent zones based, at least, on the permeability data and soil data obtained by the sensors. In some embodiments, these zones are categorized based on the analyzation of the independent zones, and the present invention determines the appropriate permeability model based, at least, on the terrain visible for that geographic location contained within the geographic representation.

Embodiments of the present invention also recognize that rate of erosion can be a concern when generating a permeability model-based geographic representation. Embodiments of the present invention provide a permeability program that analyzes the one or more geographic representations that are captured over a period of time and determines the rate of erosion for a geographic location and generates a prediction image illustrating the rate of erosion. The predicted image illustrating the rate of erosion can ameliorate such concerns of the integrity of buildings within this geographic location and whether the building will shift based, at least, on the erosion of the soil, and the rate of erosion for various embodiments including but not limited to, deforestation, river and/or stream patterns, and mud slides. When such a permeability program analyzes the data collected by the sensors, then the permeability program can leverage this data to determine the rate of erosion to communicate this information to provide safe construction of buildings, prevent mud slides, deforestation, etc. Such an approach often increases the level of safety in construction of buildings, as well as the safety and integrity of the environment and of the surrounding habitats for humans and wildlife.

Embodiments of the present invention also recognize that augmented reality is generally connected with inserting imaginative and pictographic digital media into a computing lens that a user utilizes to view reality. Embodiments of the present invention provide an augmented reality system that allows a user to identify buildings, structures, the environment, etc., within a geographic area in which the foundation of the building, structure, etc. and/or the terrain of the environment is susceptible to erosion, based, at least in part, on the various embodiments presented herein. When such an augmented reality system is presented, a user can more proactively detect and/or predict areas of erosion and can prevent destruction to buildings, structures, the environment, etc. based, at least, on the erosion discovered based on the various embodiments presented herein.

In one embodiment of the present invention, permeability program 122 executing on a computer system 120 determines at least one permeability model for, at least, one independent zone based, at least in part, on data associated with the, at least, one independent zone. Permeability program 122 determines that the at least one permeability model for, at least, one independent zone is an optimal permeability model from a plurality of permeability models. One or more geographic images are generated by permeability program 122 that are associated with, at least, the optimal permeability model for the, at least, one independent zone.

In one embodiment of the present invention, permeability program 122 receives data that includes, but is not limited to, (i) one or more images, (ii) one or more permeability data, (iii) one or more soil data, and (iv) one or more meta associated with the permeability data and soil data. Permeability program 122 analyzes the (i) one or more images, (ii) one or more permeability data, (iii) one or more soil data, and (iv) one or more meta associated with the permeability data and soil data. One or more images are positioned into one or more independent zones based, at least in part, on a user generated request by permeability program 122. Permeability program 122 identifies (i) one or more features regarding the terrain of the one or more captured images, (ii) one or more permittivity data points contained within the captured images, (iii) one or more independent zones associated with one or more captured images. Permeability program 122 determines (i) one or more identification labels describing the terrain of the one or more independent zones of, at least, one captured image.

In one embodiment of the present invention, permeability program 122 analyzes the (i) one or more captured images, (ii) one or more features regarding the terrain of the one or more captured images, (iii) one or more permeability data, (iv) one or more soil data, (iv) one or more permittivity data points, (v) one or more independent zones associated with the one or more captured images. Permeability program 122 determines the optimal permeability model for each independent zone within, at least, one captured image based, at least in part, on the analyzation of the (i) one or more captured images, (ii) one or more features regarding the terrain of the one or more captured images, (iii) one or more permeability data, (iv) one or more soil data, (iv) one or more permittivity data points, (v) one or more independent zones associated with the one or more captured images.

In one embodiment of the present invention, one or more geographic representations that are associated, at least, with (i) one or more permeability models, (ii) one or more independent zones, (iii) at least one captured image, (iv) one or more permeability data, (v) one or more soil data, and (vi) one or more permittivity data points are generated by permeability program 122.

In one embodiment of the present invention, permeability program 122 receives a permeability comparison request. Permeability program 122 executes a permeability comparison against each independent zone associated with, at least, one geographic representation. The one or more independent zones associated with, at least, one geographic representation is analyzed by permeability program 122. Permeability program 122 identifies at least one permeability model associated with each independent zone of a geographic representation, respectively. Permeability program 122 determines a threshold level of accuracy that the optimal permeability model is being utilized for each independent zone of a geographic representation.

In one embodiment of the present invention, permeability program 122 receives a user generated request to execute a prediction model for one or more geographic representations. Permeability program 122 analyzes one or more geographic representation associated with the user generated request. Permeability program 122 analyzes one or more geographic representations associated with the user generated request. Additionally, permeability program 122 identifies the (i) one or more permeability models, (ii) one or more permeability data, (iii) one or more soil data, (iv) one or more identified features of the terrain present in the captured image, (v) one or more meta data, (vi) one or more identification labels, and (vii) one or more permeability labels, contained within the one or more geographic representations.

In one embodiment of the present invention, permeability program 122 determines a rate at which terrain, contained within the one or more geographic representation, erodes over a subsequent period of time. Permeability program 122 generated a predicted geographic image depicting the visual aspects of eroded terrain over a subsequent period of time.

The present invention will now be described in detail with reference to the Figures.

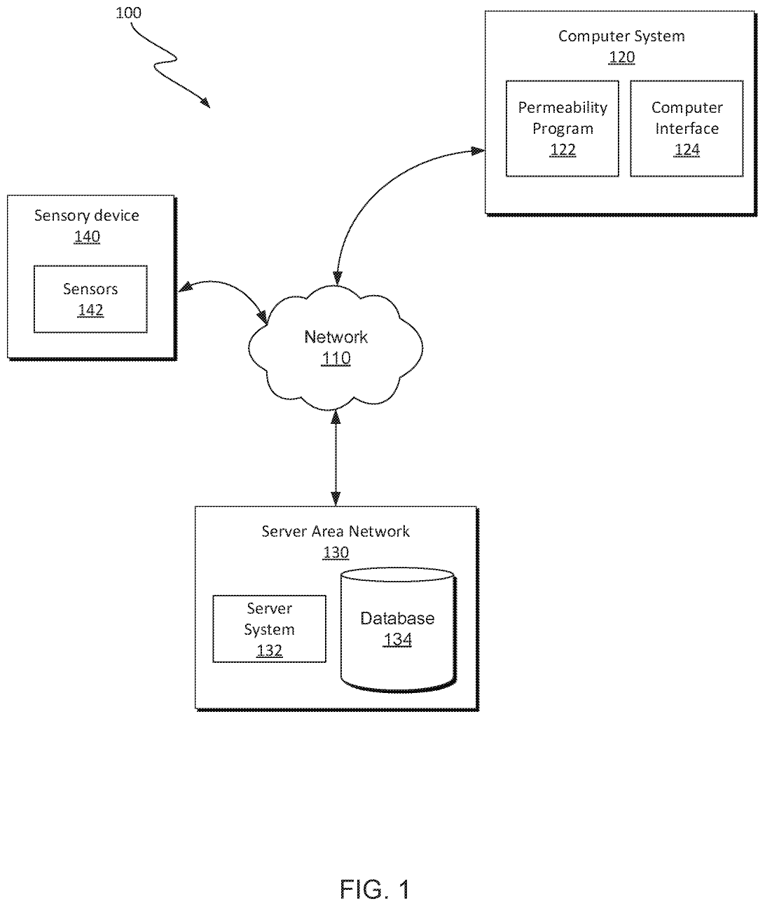

FIG. 1 is a functional block diagram illustrating a computing environment, generally designated 100 includes computer system 120, server area network (SAN) 130, and sensory device 140 connected over network 110. Computer system 120 includes permeability program 122 and computer interface 124, and sensors 126. Server area network 130 includes server system 132 and database 134. Sensory device 140 includes sensors 142.

In various embodiments of the present invention, computer system 120 is a computing device that can be a standalone device, a server, a laptop computer, a tablet computer, a netbook computer, a personal computer (PC), a personal digital assistant (PDA), a desktop computer or any programmable electronic device capable of receiving, sending, and processing data. In general, computer system 120 represents any programmable electronic device or combination of programmable electronic device capable of executing machine readable program instructions and communication with SAN 130 and sensory device 140. In another embodiment, computer system 120 represents a computing system utilizing clustered computers and components to act as a single pool of seamless resources. In general, computer system 120 can be any computing device or a combination of devices with access to SAN 130, sensory device 140, and network 110 and is capable of executing permeability program 122 and computer interface 124. Computer system 120 may include internal and external hardware components, as depicted and described in further detail with respect to FIG. 1.

In this exemplary embodiment, permeability program 122 and computer interface 124 are stored on computer system 120. However, in other embodiments, permeability program 122 and computer interface 124 may be stored externally and accessed through a communication network, such as network 110. Network 110 can be, for example, a local area network (LAN), a wide area network (WAN) such as the Internet, or a combination of the two, and may include wired, wireless, fiber optic, or any other connection known in the art. In general, network 110 can be any combination of connections and protocols that will support communications between computer system 120, SAN 130, and sensory device 140, in accordance with a desired embodiment of the present invention.

Computer system 120 includes computer interface 124. Computer interface 124 provides an interface between computer system 120 and SAN 130 and/or sensory device 140. In some embodiments, computer interface 124 can be a graphical user interface (GUI) or a web user interface (WUI) and can display text, documents, web browsers, windows, user options, application interfaces, and instructions for operation, and includes the information (such as graphic, text, and sound) that a program presents to a user and the control sequences the user employs to control the program. In some embodiments, computer system 120 accesses data communicated from SAN 130 and/or sensory device 140 via client-based application that runs on computer system 120. For example, computer system 120 includes mobile application software that provides an interface between computer system 120, SAN 130, and sensory device 140.

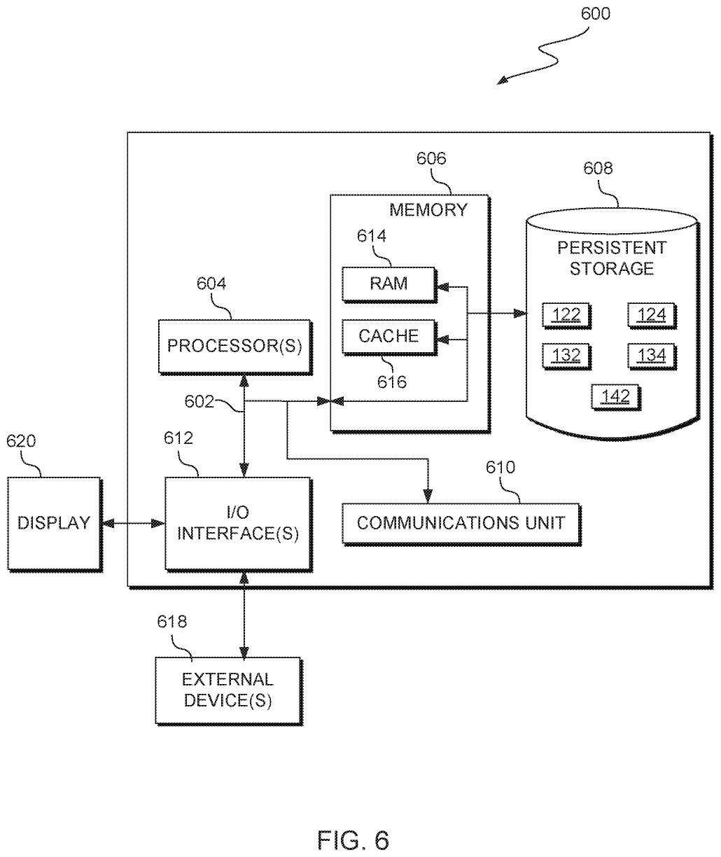

Storage area network (SAN) 130 is a storage system that includes server system 132 and database 134. SAN 130 may include one or more, but is not limited to, computing devices, servers, server-cluster, web servers, database and storage devices. SAN 130 operates to communicate with computer system 120 and sensory device 140, and various other computing systems over a network, such as network 110. For example, SAN 130 communicates with permeability program 122 to transfer data between, but is not limited, database 134 and various other databases (not shown) that are connected to network 110. In general, SAN 130 can be any computing device or combination of devices that are communicatively connected to a local IoT network, i.e., a network comprised of various computing systems and sensory devices including but are not limited to computer system 120 and sensory device 140, to provide functionality described herein. SAN 130 can include internal and external hardware components as described with respect to FIG. 6. The present invention recognizes that FIG. 1 may include any number of computing devices, servers, databases and/or storage devices, and the present invention is not limited to only what is depicted in FIG. 1. As such, in some embodiments, some or all of the features and functions of SAN 130 are included as part of computing system 120 and/or another computing system. Similarly, in some embodiments, some of the features and functions of computer system 120 are included as part of SAN 130 and/or another computing system.

Additionally, in some embodiments, SAN 130 represents a cloud computing platform. Cloud computing is a model or service delivery for enabling convenient, on demand network access to a shared pool of configurable computing resources (e.g., networks, network bandwidth, servers, processing, memory, storage, applications, virtual machines, and services) that can be rapidly provisioned and released with minimal management effort or interaction with a provider of a service. A cloud model may include characteristics such as on-demand self-service, broad network access, resource pooling, rapid elasticity, and measured service, can be represented by service models including a platform as a service (PaaS) model, an infrastructure as a service (IaaS) model, and a software as a service (SaaS) model, and can be implemented as various deployment models including as a private cloud, a community cloud, a public cloud, and a hybrid cloud.

In various embodiments, server system 132 is depicted in FIG. 1, for illustrative simplicity. However, it is to be understood that, in various embodiments, server system 132 can include nay number of databases that are managed in accordance with the functionality of server system 132. In general, database 134 represents data and server system 132 manages the ability to view the data. In other embodiments, server system 132 represents code that provides an ability to take specific action with respect to another physical or virtual resource and manages the ability to use and modify the data. In some embodiments, permeability program 122 can also represent any combination of the aforementioned features in which server system 132 has access to database 134. To illustrate various aspects of the present invention, examples of permeability program 122 are presented in which permeability program 122 represents one or more of, but is not limited to, a permeability modeling-based geographic representation.

In this exemplary embodiment, server system 132 and database 134 are stored on SAN 130. However, in other embodiments, server system 132 and database 134 may be stored externally and accessed through a communication network, such as network 110. Network 110 can be, for example, a local area network (LAN), a wide area network (WAN) such as the Internet, or a combination of the two, and may include wired, wireless, fiber optic or any other connection known in the art. In general, network 110 can be any combination of connections and protocols that will support communications between computer system 120, SAN 130, and sensory device 140, and various other computer systems (not shown) in accordance with a desired embodiment of the present invention.

In the embodiment depicted in FIG. 1, permeability program 122, at least in part, has access to server system 132, database 134, and sensors 142 and can communicate data stored on SAN 130 to computer system 120 and various other computing systems (not shown).

In various embodiment depicted in FIG. 1, permeability data is, at least, in part, data obtained from sensors 142. Sensors 142 operate to monitor and transmit data from various devices to permeability program 122. In some embodiments, sensors 142 operate to monitor and transmit data from various devices to server system 132.

In the embodiment depicted in FIG. 1, permeability program 122 utilizes, at least in part, data stored on database 134 to manage generation of permeability prediction cycle in response to receiving a modeling request based, at least in part, on a geo-fenced perimeter from computer system 120 (i.e., from a user of computer system 120, alternatively referred to herein as “requestor”). More specifically, permeability program 122 defines a resource hierarchy that represents various permeability prediction cycles and associates various permeability models and data received from sensors 142 with the various permeability prediction cycles with computer system 120.

In various embodiments depicted in FIG. 1, database 134 operates to store data as a repository for permeability program 122 and computer system 120. In some embodiments, database 134 operates to store data as a repository for sensors 142, as well as various other computer system (not shown). More specifically, database 134 stores (i) permeability data and soil data (i.e., data obtained from sensors 142), (ii) permeability models, and (iii) geo-fenced perimeters. To illustrate various aspects of the present invention, examples of a repository are presented in which a repository represents one or a combination of a database and a permeability prediction generator, are presented. However, embodiments of a repository are not limited thereto. In various embodiments, a repository encompasses any computer resource, or combination of computer resources, that are configured to analyze one or more captured images and generate a predicted geographic image using the processes described herein. Embodiments of the present recognize that computing environment 100 may include other forms of computing devices that are known in the art.

In various embodiments, database 134 stores permeability data regarding various environments where one or more sensors 142 are placed. For example, database 134 can associate various data points, user data, permeability models, and geo-fenced perimeters with various environments.

In various embodiments, sensors 142 can represent or be of the type that would be used in weather stations or in surveying or trail cameras that could gather I/O of the surrounding environment, connected over a network, such as network 110. Sensors 142 are depicted for illustrative simplicity and can include any number of devices that are capable of collecting I/O of a surrounding environment.

In the embodiment depicted in FIG. 1, sensory device 140 and include any number of sensors and/or applications to execute the various sensors, and the present invention is not confined to what is illustrated in computing environment 100. In various embodiments, sensors 142 are positioned into the ground to analyze and retrieve data based, at least in part, on the permeability of the soil. In some embodiments, sensors 142 detects the soil type at the position in which the sensor is located. Sensors 142 store this data for subsequent use by a requestor of computer system 120. In various embodiments, sensors 142 store the data on an internal storage system which can be downloaded onto computer system 120 and/or SAN 130 by a requestor. In various embodiments, sensors 142 include wireless communication systems and communicate the data to computer system 120. In some embodiments, sensors 142 communicate the data to SAN 130.

In various embodiments, sensors 142 represent one or more cameras that are capable of capturing images of various plots of land that represent geographic representations. Sensors 142 communicate these images to SAN 130. In an alternative embodiment, server system 132 executing on SAN 130 communicates a set of program instructions to sensors 142 instructing sensors 142 to communicate the captured images to SAN 130. In various embodiments, SAN 130 stores the images on database 134.

In various embodiments of the present invention, a user of computer system 120 utilizes permeability program 122 to define one or more independent zones encompassing an illustrative image. Permeability program 122 communicates with database 134 and retrieves one or more captured images that are stored on database 134. Permeability program 122 populates the one or more captured images on computer interface 124. In various embodiments, permeability program 122 utilizes the permeability data and soil data obtained by sensors 142 to determine the permeability of various zones within the image. In some embodiments, permeability program 122 communicates this data to a user of computer system 120 through an alert presented on computer interface 124, informing the user of computer system 120 of the determined permeability of the various zones located within the image. In various embodiments, a user of computer system 120 utilizes software incorporated into permeability program 122 to define one or more designed zones on the image based, at least in part, on the permeability data and soil data.

In various embodiments of the present invention, permeability program 122 analyzes the captured image. In various embodiments, the captured image includes, but is not limited to, features that encapsulate the characteristics of the planet's terrain. In various embodiments and examples of the present invention, the one or more captured images includes any number of zones and is not limited to what is described herein. In one embodiment and example, permeability program 122 analyzes the captured image and identifies various features regarding the terrain. In this example and embodiment, permeability program 122 identifies that zone 1 of the captured image includes, but is not limited to, features that represent a mountainous region (e.g., high elevation, mountain peaks, snow, and/or alpine vegetation). Additionally, permeability program 122 identifies that zone 2 of the captured image includes, but is not limited to, features that represent a low-level plain that includes a body of water (e.g., a stream, river, and/or a lake). Lastly, permeability program 122 identifies that zone 3 of the captured image includes, but is not limited to, features that represent an oceanic island that includes thermal activity (e.g., a volcano). The present invention recognizes that a captured image includes any number of zones and includes any number of terrains that are known in the art. One having ordinary skill in the art would understand that a zone is represented by a geo-fenced area that can be established and/or altered by a user of computer system 120. Additionally, one having ordinary skill in the art would understand that a terrain represents physical features of land and/or a body of water. Permeability program 122 generates one or more zoned images, based at least in part, on (i) the identification of various terrain features of the image, and (ii) the user defined zones of the image. Permeability program 122 stores the one or more zoned images on a database (e.g., database 134).

In various embodiments, based, at least in part, on the identification of the zones of the captured image (i.e., zoned image), permeability program 122 notifies the user of computer system 120 and affixes an identification label to each zone articulating the features identified for the one or more zoned images. Permeability program 122 stores the labeled zoned image on a database (e.g., database 134).

In the embodiment depicted in FIG. 1, permeability program 122 accesses database 134 and retrieves the permeability data and the soil data collected by sensors 142. Permeability program 122 analyzes the (i) permeability data, (ii) soil data, and (iii) the meta data associated with the permeability data and soil data. One having ordinary skill in the art would understand that the metadata represents, but is not limited to, (i) the geographic location of where the permeability data and soil data were collected by sensors 142, and (ii) the time and date in which the permeability data and soil data were collected by sensors 142, but the metadata is not limited to these features. Permeability program 122 identifies characteristics of the permeability data and soil data that include, but are not limited to, porosity, soil type, soil water content, permittivity of rocks and soil, and rock composition. Permeability program 122 generates one or more permeability labels based, at least in part, on the (i) permeability data, (ii) soil data, and (iii) metadata and affixes the one or more permeability labels to the respective identified zones, as discussed above, of the zoned images.

In various embodiments, permeability program 122 stores the one or more zoned images that include, but are not limited to, (i) one or more defined zones, (ii) permeability data and soil data, (iii) identified features of the terrain present in the captured image, (iv) meta data, (v) one or more identification labels, and (vi) one or more permeability labels on database 134.

In various embodiments, a user of computer system 120 generates a request for one or more zoned images. Based, at least in part, on the request by the user of computer system 120, permeability program 122 communicates with SAN 130 and accesses database 134. Permeability program 122 retrieves the one or more zoned images based, at least in part, on the request generated by the user of computer system 120 and populates the one or more zoned images on computer interface 124. In an alternative embodiment, permeability program 122 communicates the request to server system 132 with program instructions instructing server system 132 to access database 134 and retrieve the one or more zoned images based, at least in part, on the request. Additionally, in this alternative embodiment, permeability program 122 further instructs server system 132 to communicate the one or more retrieved zoned images and communicate the one or more retrieved zoned images to permeability program 122, wherein permeability program 122 receives the one or more retrieved zoned images and populates the zoned images on computer interface 124.

Permeability program 122 based, at least in part, on the user interactions made by the user of computer system 120, analyzes the one or more zoned images and identifies features contained within the one or more zoned images, but is not limited to, (i) one or more defined zones, (ii) permeability data and soil data, (iii) identified features of the terrain present in the captured image, (iv) meta data, (v) one or more identification labels, and (vi) one or more permeability labels contained within the one or more zoned images. Permeability program 122 communicates the identified features to the user of computer system 120 and further identifies the respective permeability models utilized for each respective zone within the one or more zoned images. In various embodiments of the present invention, the one or more zoned images contains one or more zones, respectively.

In one embodiment and example, a first zoned image contains three independent zones (i.e., geo-fenced sections). Permeability program 122 determines based, at least in part, on the (i) identification labels, (ii) permeability labels, and (iii) analyzation of the zoned image, that the first independent zone of the first zoned image contains vegetation overgrowth, the second independent zone contains thermal activity, and the third independent one contains dense geological rock formations. Additionally, based, at least in part, on the determination of the terrain type of the three independent zones, permeability program 122 further determines the appropriate permeability model with respect to the terrain type of the three independent zones.

In some embodiments, permeability program 122 determines that physical triangulation and/or line of sight permeability models are ineffective based, at least in part, on the identification of vegetation overgrowth in the first independent zone. Permeability program 122 further determines that kerogen permeability model, which relies on the soil and rock make-up would be an appropriate permeability model for the first independent zone, respectively. With respect to the second independent zone of this embodiment and example, permeability program 122 determines that a thermal permeability models are ineffective based, at least in part, on the identification of thermal activity (e.g., volcanoes erupting) in the second independent zone. Permeability program 122 further determines that kerogen permeability model, which relies on the soil and rock formations, would be an appropriate permeability model for the second independent zone, respectively. With respect to the third independent zone of this embodiment and example, permeability program 122 determines that ground penetrating radar (GDR) permeability models are less effective based, at least in part, on the identification of dense geological rock formations in the third independent zone. Permeability program 122 further determines that either a thermal imaging permeability model and/or a kerogen permeability model would be an appropriate permeability model for the third independent zone, respectively.

Permeability program 122 communicates a notification to computer interface 124 and populates a notification to the user of computer system 120, informing the user of the determination of which permeability model to use for each independent zone of a zone image, respectively. Permeability program 122 prompts the user to approve or deny the permeability model selected by permeability program 122 for each independent zone. In some embodiments, the user of computer system 120 approves the selected permeability models and permeability program 122 stores the one or more zoned images on database 134. In various embodiments, the user of computer system 120 denies the selected permeability models and permeability program 122 presents a list of permeability models that the user may select from, for each independent zone, respectively. Based, at least in part, on the selection of a permeability model by a user of computer system 120, permeability program 122 updates the one or more zones, respectively, and stores the one or more zoned images on database 134.

In various embodiments of the present invention, permeability program 122 retrieves, at least, one zoned image from database 134, as discussed above, and generates a geographic representation-based permeability modeling that includes, but is not limited to, (i) one or more permeability models, (ii) permeability data and soil data, (iii) identified features of the terrain present in the captured image, (iv) meta data, (v) one or more identification labels, and (vi) one or more permeability labels. Permeability program 122 populates the permeability modeling-based geographic representation on computer interface 124 for the user of computer system 120. In some embodiments, permeability program 122 stores the permeability modeling-based geographic representation on database 134 for subsequent by a user of computer system 120 and/or various other computer systems (not shown).

In one embodiment, and example, a user on computer system 120 requests permeability program 122 to execute a permeability comparison (i.e., comparison request) against each independent zone within, at least, one permeability modeling-based geographic representation. In this embodiment and example, the comparison request operates to analyze the permeability modeling assigned to each independent zone of the permeability modeling-based geographic representation, respectively, and determine whether the confidence reaches a threshold value that the correct permeability model has been assigned to each independent zone.

In various embodiments of the present invention, permeability program 122 retrieves, at least, one permeability modeling-based geographic representation from database 134 based, at least in part, on the comparison request made by the user of computer system 120. Permeability program 122 analyzes the, at least, one permeability modeling-based geographic representation and identifies the permeability models assigned to each independent zone (e.g., GPR, kerogen, thermal, etc.), respectively. Permeability program 122 executes a permeability-modeling comparison application based, at least in part, on the comparison request, to determine whether the identified permeability model reaches a threshold level of accuracy that the identified permeability model is the correct permeability model for each independent zone, respectively.

In some embodiments, permeability program 122 executes a permeability-modeling comparison application on a first permeability modeling-based geographic representation that includes, but is not limited to, three independent zones. Permeability program 122 analyzes the three independent zones and identifies the permeability label which includes, but is not limited to, a permeability model, assigned to each of the three independent zones. Permeability program 122 identifies the threshold level of accuracy that the correct permeability model, for each of the three independent zones, respectively. For example, permeability program 122 identifies that one out of the three independent zones did not reach the threshold level of accuracy that the correct permeability model was assigned to the zone. Permeability program 122 analyzes the zone that did not reach the threshold level of accuracy. Permeability program 122 determines that the zone was assigned a GDR permeability model based, at least in part, because the zone contained vegetation overgrowth, however, based on the further analyzation of permeability program 122, permeability program 122 identifies that the zone contains dense geological rock formations and a GDR permeability model would be ineffective in measuring the permeability of the zone. Permeability program 122 determines that a kerogen permeability model reaches the threshold level of accuracy and assigns a kerogen permeability label to the zone.

In one embodiment and example, permeability program 122 executes a permeability-modeling comparison application on a permeability modeling-based geographic representation that includes, but is not limited to, three independent zones. Permeability program 122 analyzes the three independent zones and identifies the permeability label which includes, but is not limited to, a permeability model, assigned to each of the three independent zones. Permeability program 122 identifies the threshold level of accuracy that the correct permeability model, for each of the three independent zones, respectively. Permeability program 122 further identifies that one out of the three independent zones does not reach the threshold level of accuracy that the correct permeability model has been assigned to the zone that did not reach the threshold level of accuracy. Permeability program 122 further analyzes the zone that did not reach the threshold level of accuracy. Permeability program 122 determines, based, at least in part, on the analyzation of the zone, that every permeability model does not reach the threshold level of accuracy. Permeability program 122 analyzes the threshold values for each permeability model of the zone and determines the highest value out of the permeability models. In this embodiment and example, permeability program 122 selects the permeability model with the closest value to the threshold level of accuracy and assigns that permeability model to the zone.

In various embodiments of the present invention, sensors 142 gathers (i) permeability data, (ii) soil data, (iii) meta data, and (iv) images of various plots of land over a period of time. One having ordinary skill in the art would understand that a period of time includes, but is not limited to, any incremental time period known in the art (i.e., minutes, hours, days, weeks, months, etc.). As discussed above, sensors 142 communicates this data server system 132 and stored on database 134. In an alternative embodiment permeability program 122 communicates a set of program instructions to sensors 142 instructing sensors 142 to communicate the data to server system 132 and store the data on database 134. This data represents a trendline of various data points over a period of time relating to a plot of land represented by an image.

In one embodiment and example, a user of computer system 120 requests permeability program 122 to generate a prediction model based, at least in part, on the one or more permeability modeling-based geographic representation stored on database 134. Permeability program 122 generates a prediction model request and communicates the request to server system 132, along with program instructions instructing server system 132 to access database 134 and retrieve one or more permeability modeling-based geographic representation based, at least, on the prediction model request, and transmit the data to permeability program 122. One having ordinary skill in the art would understand that to generate a prediction model and/or trendline, similar data from the identical or closely related sensors 142 is necessary to complete to generate the prediction and/or trendline.

In this embodiment and example, permeability program 122 analyzes the one or more permeability modeling-based geographic representation and identifies the (i) one or more permeability models, (ii) one or more permeability data and one or more soil data, (iii) one or more identified features of the terrain present in the captured image, (iv) one or more meta data, (v) one or more identification labels, and (vi) one or more permeability labels contained within the one or more permeability modeling-based geographic representation. Permeability program 122 based, at least in part, on the identification and analyzation of the one or more permeability modeling-based geographic representation, determines the rate at which the soil and terrain, contained within the one or more geographic representations, will continue to erode over a period of time. One having ordinary skill in the art would understand that the higher the permittivity of the soil and/or terrain of a defined section of land will erode at an increased rate of time than that of a lower permittivity.

In various embodiments of the present invention, permeability program 122 based, at least in part, on the determination of the rate of time in which the soil and/or terrain will erode based, at least in part, on the (i) permittivity and (ii) the permeability data and soil data, generates a predicted image depicting the visual aspects of the terrain will erode over a defined period of time of geographic representation. Permeability program 122 populates the predicted image on computer interface 124 for the user of computer system 120. Additionally, permeability program 122 stores the predicted image on database (e.g., database 134).

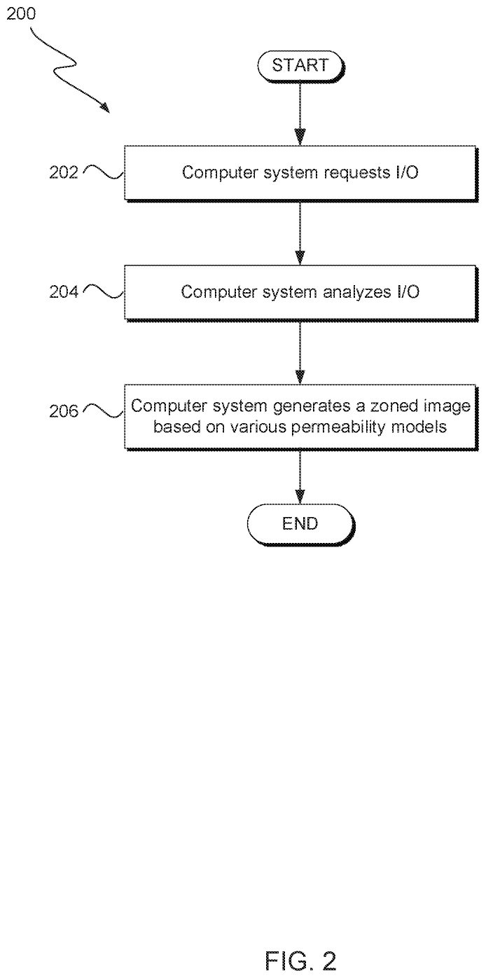

FIG. 2 is a flowchart depicting operations for generating a permeability modeling-based geographic representation for computing environment 100, in accordance with an illustrative embodiment of the present invention. More specifically, FIG. 2, depicts combined overall operations 200, of permeability program 122 executing on computer system 120. In some embodiments, operations 200 represents logical operations of permeability program 122, wherein computer interface 124 represents interactions between logical units executing on computer system 120. It should be appreciated that FIG. 2 provides an illustration of one implementation and does not imply any limitations with regard to the environments in which different embodiments may be implemented. Many modifications to the depicted environment may be made. In one embodiment of flowchart 200, the series of operations can be performed in any order. In another embodiment, the series of operations, of flowchart 200, can be performed simultaneously. Additionally, the series of operations, in flowchart 200, can be terminated at any operation. In addition to the features previously mentioned, any operations, of flowchart 200, can be resumed at any time.

In operation 202, permeability program 122 executing on computer system 120 communicates a request to SAN 130 for I/O. As discussed above, I/O includes, but is not limited to, (i) one or more captured images, (ii) one or more permeability data, (iii) one or more soil data, and (iv) one or more meta data associated with the permeability data and soil data. In an alternative embodiment, permeability program 122 communicates a set of program instructions instructing server system 132 to transmit the I/O based, at least in part, on (i) a request generated by a user of computer system 120 or (ii) by periodic intervals. One having ordinary skill in the art would understand that periodic time intervals represents periods of time (e.g., every 5 minutes, top of the hour, every 4 hours, etc.). Additionally, one having ordinary skill in the art would understand that periodic intervals includes, but is not limited to, transmitting I/O during a time period when SAN 130 receives I/O from sensors 142.

In operation 204, permeability program 122 analyzes the I/O received from SAN 130. In various embodiments, permeability program 122 analyzes the (i) one or more captured images, (ii) one or more permeability data, (iii) one or more soil data, and (iv) one or more meta data associated with the permeability data and soil data. Permeability program 122 identifies based, at least in part, on the analyzation of the I/O, (i) various features regarding the terrain of the one or more captured images, (ii) various permittivity points contained within the captured image, (iii) one or more independent zones within the one or more captured images, and (iv) various data points contained within the metadata (e.g., time stamps, etc.). In various embodiments, permeability program 122 determines, based, at least in part, on the analyzation performed by permeability program 122, (i) one or more identification labels describing the terrain of the one or more independent zones of a captured image, and (ii) one or more permeability labels describing the permeability model associated with each of the one or more independent zones, respectively.

In various embodiments, permeability program 122 analyzes the (i) one or more captured images, (ii) one or more permeability data, (iii) one or more soil data, and (iv) one or more meta data associated with the permeability data and soil data. Additionally, based, at least in part, on the analyzation, permeability program 122 identifies the respective permeability models utilized for each respective independent zone within the one or more zoned images. Permeability program 122 determines the optimal permeability model for the one or more independent zones based, at least in part, on the analyzation of the above data. In various embodiment of the present invention, the one or more zoned images contained one or more independent zones, respectively.

In various embodiments of the present invention, permeability program 122 analyzes the (i) one or more captured images, (ii) one or more permeability data, (iii) one or more soil data, and (iv) one or more meta data associated with the permeability data and soil data. Permeability program 122 based, at least, on the analyzation, identifies the characteristics of the terrain within the one or more independent zones. Additionally, based, at least, on the identification of the characteristics of the terrain, permeability program 122 determines the optimal permeability model for each independent zone, respectively.

In one embodiment and example, permeability program 122 determines that physical triangulation and/or line of sight permeability models are ineffective based, at least in part, on the identification of vegetation overgrowth in, at least, a first independent zone. Permeability program 122 further determines that kerogen permeability model, which relies on the soil and rock make-up would be an appropriate permeability model for the first independent zone, respectively.

In one embodiment and example, permeability program 122 determines that a thermal permeability models are ineffective based, at least in part, on the identification of thermal activity (e.g., volcanoes erupting) in, at least, a second independent zone. Permeability program 122 further determines that kerogen permeability model, which relies on the soil and rock formations, would be an appropriate permeability model for the second independent zone, respectively.

In one embodiment and example, permeability program 122 determines that ground penetrating radar (GDR) permeability models are less effective based, at least in part, on the identification of dense geological rock formations in, at least, a third independent zone. Permeability program 122 further determines that either a thermal imaging permeability model and/or a kerogen permeability model would be an appropriate permeability model for the third independent zone, respectively.

In operation 206, permeability program 122 generates a permeability modeling-based geographic representation that includes, but is not limited to, (ii) one or more permeability data, (iii) one or more soil data, and (iv) one or more meta data associated with the permeability data and soil data, (v) various features regarding the terrain of the one or more captured images, (vi) various permittivity points contained within the captured image, (vii) one or more independent zones within the captured image, and (viii) various data points contained within the metadata (e.g., time stamps, etc.), (iv) one or more identification labels describing the terrain of the one or more independent zones of the captured image, and (x) one or more permeability labels describing the permeability model associated with each of the one or more independent zones, respectively. In various embodiments, permeability program 122 generates one or more permeability modeling-based geographic representations associated with data and sensors 142 with respect to the same and/or similar geographic location. In an alternative embodiment, permeability program 122 generates one or more permeability modeling-based geographic representations that are associated with I/O and sensors 142 with respect to a plurality of geographic locations which include, but are not limited to, different geographic locations that are not identical. In various embodiments, permeability program 122 populates the one or more permeability modeling-based geographic representations on computer interface 124 based, at least, on the request made by the user of computer system 120. In some embodiments, permeability program 122 stores the one or more permeability modeling-based geographic representations on a database (e.g., database 134) for subsequent use by a user of computer system 120 and/or various other computer systems (not shown).

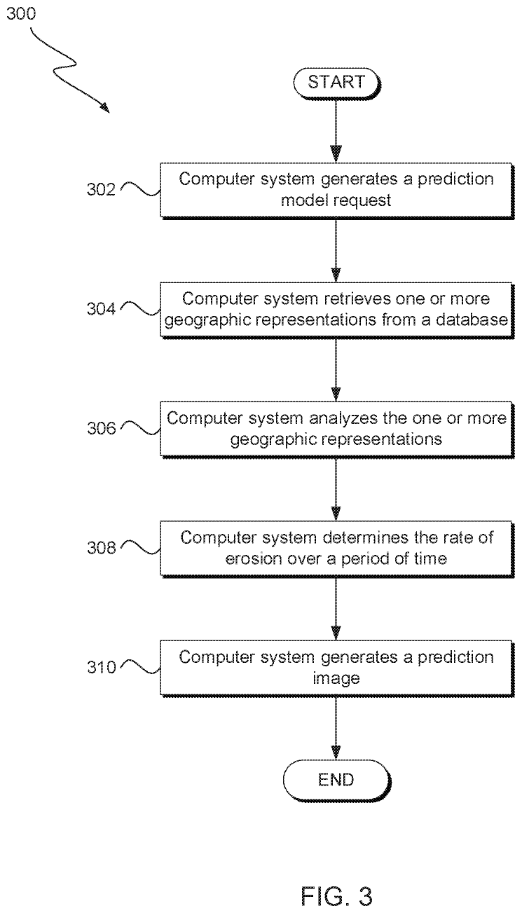

FIG. 3 is a flowchart depicting operations for generating a prediction image for computing environment 100, in accordance with an illustrative embodiment of the present invention. More specifically, FIG. 3, depicts combined overall operations 300, of permeability program 122 executing on computer system 120. In some embodiments, operations 300 represents logical operations of permeability program 122, wherein computer interface 124 represents interactions between logical units executing on computer system 120. Further, operations 300 can include a portion or all of combined overall operations of 200. It should be appreciated that FIG. 3 provides an illustration of one implementation and does not imply any limitations with regard to the environments in which different embodiments may be implemented. Many modifications to the depicted environment may be made. In one embodiment of flowchart 300, the series of operations can be performed in any order. In another embodiment, the series of operations, of flowchart 300, can be performed simultaneously. Additionally, the series of operations, in flowchart 200, can be terminated at any operation. In addition to the features previously mentioned, any operations, of flowchart 200, can be resumed at any time.

In operation 302, a user of computer system 120 communicates to permeability program 122 to generate a prediction image based, at least in part, on one or more permeability modeling-based geographic representations. In various embodiments, permeability program 122 generates a prediction image request and communicates the request to server system 132 operating on SAN 130. Permeability program 122 further communicates a set of program instructions instructing server system 132 to access database 134 and/or various other databases (not shown) and retrieve one or more permeability modeling-based geographic representations based, at least in part, on the request. Based, at least, on the set of program instructions, server system 132 communicates the one or more retrieved permeability modeling-based geographic representations. In alternative embodiment, permeability program 122 access database 134 and/or various other databases (not shown) and retrieves one or more permeability modeling-based geographic representations based, at least in part, on the request (operation 304).

In operation 306, permeability program 122 analyzes the one or more retrieved permeability modeling-based geographic representations. Permeability program 122 identifies, at least, within the one or more retrieved permeability modeling-based geographic representations: (i) one or more permeability models, (ii) one or more permeability data and one or more soil data, (iii) one or more identified features of the terrain present in the captured image, (iv) one or more meta data, (v) one or more identification labels, and (vi) one or more permeability labels contained within the one or more permeability modeling-based geographic representation. In addition, permeability program 122 analyzes each identified element of the one or more retrieved permeability modeling-based geographic representation to determine the rate of erosion.

In operation 308, permeability program 122 determines based, at least in part, on the analyzation performed in operation 306, the rate at erosion of the geographic location contained within the one or more permeability modeling-based geographic representations. In various embodiments, permeability program 122 determines the rate at which the local soil, contained within the geographic location of the one or more geographic representations, will erode over a period of time. Permeability program 122 determines the rate at which the ground will erode to predict the integrity of buildings within this geographic location and whether the building will shift based, at least, on the erosion of the soil. Permeability program 122 further determines the rate of erosion for various embodiments including, but is not limited to, deforestation, river and/or stream patterns, and mud slides.

In operation 310, permeability program 122 generates a prediction image based, at least in part, on the analyzation in operation 306 and the determination in operation 308. In various embodiments, permeability program 122 generates one or more prediction images for the geographic location of the permeability modeling-based geographic representation, respectively. In addition, the one or more prediction images include, but are not limited to, images depicting the erosion levels over one or more periods of time. For example, permeability program 122 generates one or more prediction images that are associated with one or more periods of time (i.e., six months, 1 year, 2 years, 5, years, etc.). Permeability program 122 generates, at least, one prediction image that includes the one or more prediction images that are associated with one or more periods of time. Permeability program 122 layers the one or more prediction images associated with one or more periods of time to generate one cohesive prediction image. Permeability program 122 populates the predicted image on computer interface 124 for the user of computer system 120. In some embodiments, permeability program 122 stores the predicted image on a database (e.g., database 134) for subsequent use by a user.

In various embodiments, permeability program 122 generates one prediction image based, at least, on the request by a user, associated with a singular period of time. In this embodiment, permeability program 122 generates a predicted image based on a singular period of time, the predicted image illustrates the extent that the rate of erosion would occur over this singular period of time (i.e., 5 years). Permeability program 122 layers the predicted image over the permeability modeling-based geographic representation and includes a rate of erosion label describing the extent the rate of erosion would occur. Permeability program 122 populates the predicted image on computer interface 124 for the user of computer system 120. In some embodiments, permeability program 122 stores the predicted image on a database (e.g., database 134) for subsequent use by a user.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

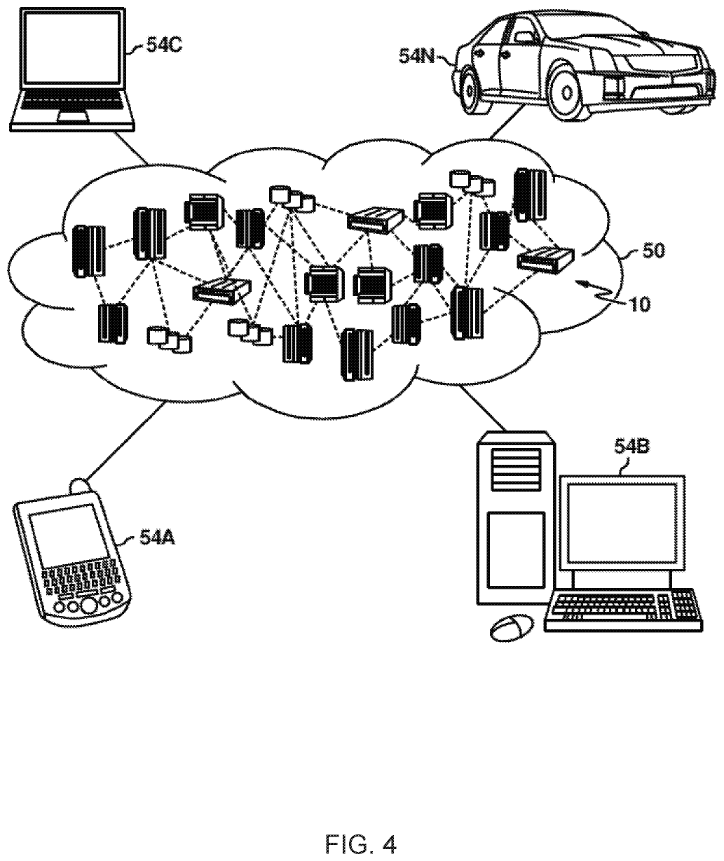

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

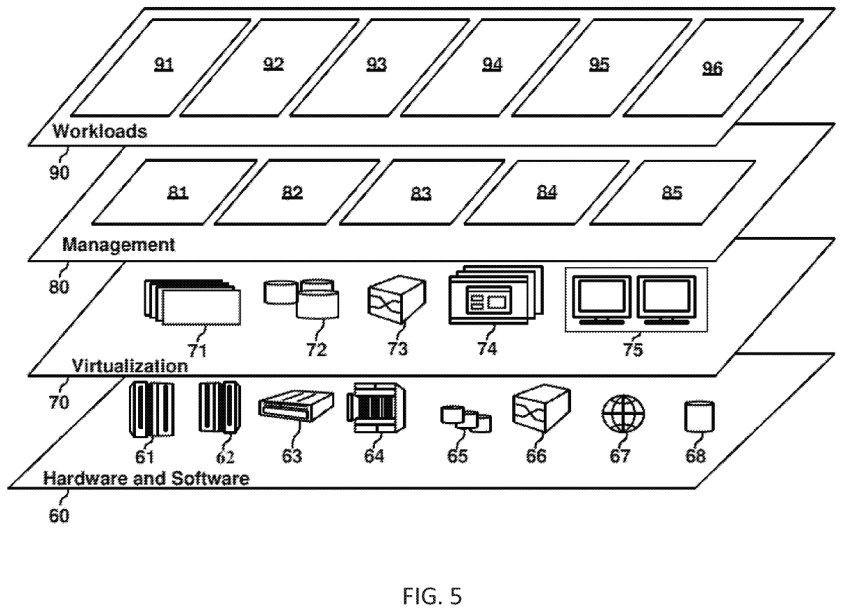

Referring now to FIG. 5 a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing soothing output 96.

FIG. 6 depicts a block diagram, 600, of components of computer system 120, SAN 130, and sensory device 140, in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Computer system 120, SAN 130, and sensory device 140 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer-readable storage media. In this embodiment, memory 606 includes random access memory (RAM) 614 and cache memory 616. In general, memory 606 can include any suitable volatile or non-volatile computer-readable storage media.

Permeability program 122, computer interface 124, server system 132, database 134, and sensors 142 are stored in persistent storage 608 for execution and/or access by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 610, in these examples, provides for communications with other data processing systems or devices, including resources of network 110. In these examples, communications unit 610 includes one or more network interface cards. Communications unit 610 may provide communications through the use of either or both physical and wireless communications links. Permeability program 122, computer interface 124, server system 132, database 134, and sensors 142 may be downloaded to persistent storage 608 through communications unit 610.

I/O interface(s) 612 allows for input and output of data with other devices that may be connected to computer system 120, SAN 130, and sensory device 140. For example, I/O interface 612 may provide a connection to external devices 618 such as a keyboard, keypad, a touch screen, and/or some other suitable input device. External devices 618 can also include portable computer-readable storage media such as, for example, thumb drives, portable optical or magnetic disks, and memory cards. Software and data used to practice embodiments of the present invention, e.g., permeability program 122, computer interface 124, server system 132, database 134, and sensors 142, can be stored on such portable computer-readable storage media and can be loaded onto persistent storage 608 via I/O interface(s) 612. I/O interface(s) 612 also connect to a display 620.

Display 620 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as, for example, “Smalltalk” and the like may be subject to trademark rights in various jurisdictions throughout the world and are used here only in reference to the products or services properly denominated by the marks to the extent that such trademark rights may exist.

What is claimed is:

1. A computer-implemented method, the method comprising:
determining, by one or more processors, at least one permeability model for, at least, one independent zone based, at least in part, on data associated with the, at least, one independent zone;
determining, by one or more processors, that the at least one permeability model for, at least, one independent zone is an optimal permeability model from a plurality of permeability models; and
generating, by one or more processors, one or more predicted geographic images that are associated with, at least, the optimal permeability model for the, at least, one independent zone.

2. The computer-implemented method of claim 1, the method further comprising:
receiving, by the one or more processors, data that includes, (i) one or more images, (ii) one or more permeability data, (iii) one or more soil data, and (iv) one or more meta associated with the permeability data and soil data;
analyzing, by the one or more processors, the (i) one or more images, (ii) one or more permeability data, (iii) one or more soil data, and (iv) one or more meta associated with the permeability data and soil data;
partitioning, by the one or more processors, the one or more images into one or more independent zones based, at least in part, on a user generated request;
identifying, by the one or more processors, (i) one or more features regarding terrain of the one or more captured images, (ii) one or more permittivity data points contained within the captured images, (iii) one or more independent zones associated with one or more captured images; and
determining, by the one or more processors, (i) one or more identification labels describing the terrain of the one or more independent zones of, at least, one captured image.

3. The computer-implemented method of claim 1, the method further comprising:
analyzing, by the one or more processors, the (i) one or more captured images, (ii) one or more features regarding the terrain of the one or more captured images, (iii) one or more permeability data, (iv) one or more soil data, (iv) one or more permittivity data points, (v) one or more independent zones associated with the one or more captured images; and
determining, by the one or more processors, the optimal permeability model for each independent zone within, at least, one captured image based, at least in part, on the analyzation of the (i) one or more captured images, (ii) one or more features regarding the terrain of the one or more captured images, (iii) one or more permeability data, (iv) one or more soil data, (iv) one or more permittivity data points, (v) one or more independent zones associated with the one or more captured images.

4. The computer-implemented method of claim 1, the method further comprising:
generating, by the one or more processors, one or more geographic representations that are associated, at least, with (i) one or more permeability models, (ii) one or more independent zones, (iii) at least one captured image, (iv) one or more permeability data, (v) one or more soil data, and (vi) one or more permittivity data points.

5. The computer-implemented method of claim 1, the method further comprising:
receiving, by the one or more processors, a permeability comparison request;
executing, by the one or more processors, a permeability comparison against each independent zone associated with, at least, one geographic representation;
analyzing, by the one or more processors, the one or more independent zones associated with, at least, one geographic representation;
identifying, by the one or more processors, at least one permeability model associated with each independent zone of a geographic representation, respectively; and
determining, by the one or more processors, a threshold level of accuracy that the optimal permeability model is being utilized for each independent zone of a geographic representation.

6. The computer-implemented method of claim 1, the method further comprising:
receiving, by the one or more processors, a user generated request to execute a prediction model for one or more geographic representations;
analyzing, by the one or more processors, the one or more geographic representations associated with the user generated request; and
identifying, by the one or more processors, the (i) one or more permeability models, (ii) one or more permeability data, (iii) one or more soil data, (iv) one or more identified features of terrain present in the captured image, (v) one or more meta data, (vi) one or more identification labels, and (vii) one or more permeability labels, contained within the one or more geographic representations.

7. The computer-implemented method of claim 1, the method further comprising:
determining, by the one or more processors, a rate at which terrain, contained within the one or more geographic representation, erodes over a subsequent period of time; and
generating, by the one or more processors, a predicted geographic image depicting visual aspects of eroded terrain over a subsequent period of time.

8. A computer program, the computer program product comprising:
one or more computer-readable storage media and program instructions stored on the one or more computer-readable storage media, the program instructions comprising:
program instructions to determine at least one permeability model for, at least, one independent zone based, at least in part, on data associated with the, at least, one independent zone;
program instructions to determine that the at least one optimal permeability model for, at least, one independent zone is an optimal permeability model from a plurality of permeability models; and
program instructions to generate one or more predicted geographic images that are associated with, at least, the optimal permeability model for the, at least, one independent zone.

9. The computer program product of claim 8, the program instructions further comprising:
program instructions to receive data that includes, (i) one or more images, (ii) one or more permeability data, (iii) one or more soil data, and (iv) one or more meta associated with the permeability data and soil data;
program instructions to analyze the (i) one or more images, (ii) one or more permeability data, (iii) one or more soil data, and (iv) one or more meta associated with the permeability data and soil data;
program instructions to partition, the one or more images into one or more independent zones based, at least in part, on a user generated request;
program instruction to identify (i) one or more features regarding terrain of the one or more captured images, (ii) one or more permittivity data points contained within the captured images, (iii) one or more independent zones associated with one or more captured images; and
program instructions to determine (i) one or more identification labels describing the terrain of the one or more independent zones of, at least, one captured image.

10. The computer program product of claim 8, the program instructions further comprising:
program instructions to analyze the (i) one or more captured images, (ii) one or more features regarding the terrain of the one or more captured images, (iii) one or more permeability data, (iv) one or more soil data, (iv) one or more permittivity data points, (v) one or more independent zones associated with the one or more captured images; and
program instructions to determine the optimal permeability model for each independent zone within, at least, one captured image based, at least in part, on the analyzation of the (i) one or more captured images, (ii) one or more features regarding the terrain of the one or more captured images, (iii) one or more permeability data, (iv) one or more soil data, (iv) one or more permittivity data points, (v) one or more independent zones associated with the one or more captured images.

11. The computer program product of claim 8, the program instructions further comprising:
program instructions to generate one or more geographic representations that are associated, at least, with (i) one or more permeability models, (ii) one or more independent zones, (iii) at least one captured image, (iv) one or more permeability data, (v) one or more soil data, and (vi) one or more permittivity data points.

12. The computer program product of claim 8, the program instructions further comprising:
program instructions to receive a permeability comparison request;
program instructions to execute a permeability comparison against each independent zone associated with, at least, one geographic representation;
program instructions to analyze the one or more independent zones associated with, at least, one geographic representation;
program instructions to identify at least one permeability model associated with each independent zone of a geographic representation, respectively; and
program instructions to determine a threshold level of accuracy that the optimal permeability model is being utilized for each independent zone of a geographic representation.

13. The computer program product of claim 8, the program instructions further comprising:
program instructions to receive a user generated request to execute a prediction model for one or more geographic representations;
program instructions to analyze the one or more geographic representations associated with the user generated request; and
program instructions to identify the (i) one or more permeability models, (ii) one or more permeability data, (iii) one or more soil data, (iv) one or more identified features of terrain present in the captured image, (v) one or more meta data, (vi) one or more identification labels, and (vii) one or more permeability labels, contained within the one or more geographic representations.

14. The program product of claim 8, the program instructions further comprising:
program instructions to determine a rate at which terrain contained within the one or more geographic representations, erodes over a subsequent period of time; and
program instructions generate a predicted geographic image depicting visual aspects of eroded terrain over a subsequent period of time.

15. A computer system, the computer system comprising:
one or more computer processors;
one or more computer-readable storage medium; and
program instructions stored on the computer-readable storage medium for execution by at least one of the one or more processors, the program instructions comprising:
program instructions to determine at least one permeability model for, at least, one independent zone based, at least in part, on data associated with the, at least, one independent zone;
program instructions to determine that the at least one optimal permeability model for, at least, one independent zone is an optimal permeability model from a plurality of permeability models; and
program instructions generate one or more predicted geographic images that are associated with, at least, the optimal permeability model for the, at least, one independent zone.

16. The computer system of claim 15, the program instructions further comprising:
program instructions to receive data that includes, (i) one or more images, (ii) one or more permeability data, (iii) one or more soil data, and (iv) one or more meta associated with the permeability data and soil data;
program instructions to analyze the (i) one or more images, (ii) one or more permeability data, (iii) one or more soil data, and (iv) one or more meta associated with the permeability data and soil data;
program instructions to partition the one or more images into one or more independent zones based, at least in part, on a user generated request;
program instructions to identify (i) one or more features regarding terrain of the one or more captured images, (ii) one or more permittivity data points contained within the captured images, (iii) one or more independent zones associated with one or more captured images; and
program instructions to determine (i) one or more identification labels describing the terrain of the one or more independent zones of, at least, one captured image.

17. The computer system of claim 15, the program instructions further comprising:
program instructions to analyze the (i) one or more captured images, (ii) one or more features regarding the terrain of the one or more captured images, (iii) one or more permeability data, (iv) one or more soil data, (iv) one or more permittivity data points, (v) one or more independent zones associated with the one or more captured images; and
program instructions to determine the optimal permeability model for each independent zone within, at least, one captured image based, at least in part, on the analyzation of the (i) one or more captured images, (ii) one or more features regarding the terrain of the one or more captured images, (iii) one or more permeability data, (iv) one or more soil data, (iv) one or more permittivity data points, (v) one or more independent zones associated with the one or more captured images.

18. The computer system of claim 15, the program instructions further comprising:
program instructions to receive a permeability comparison request;
program instructions to execute a permeability comparison against each independent zone associated with, at least, one geographic representation;
program instructions to analyze the one or more independent zones associated with, at least, one geographic representation;
program instructions to identify at least one permeability model associated with each independent zone of a geographic representation, respectively; and
program instructions to determine a threshold level of accuracy that the optimal permeability model is being utilized for each independent zone of a geographic representation.

19. The computer system of claim 15, the program instructions further comprising:
program instructions to receive a user generated request to execute a prediction model for one or more geographic representations;
program instructions to analyze the one or more geographic representations associated with the user generated request; and
program instructions to identify the (i) one or more permeability models, (ii) one or more permeability data, (iii) one or more soil data, (iv) one or more identified features of terrain present in the captured image, (v) one or more meta data, (vi) one or more identification labels, and (vii) one or more permeability labels, contained within the one or more geographic representations.

20. The computer system of claim 15, the program instructions further comprising:
program instructions to determine a rate at which terrain, contained with the one or more geographic representations, erodes over a subsequent period of time; and
program instructions to generate a predicted geographic image depicting visual aspects of eroded terrain over a subsequent period of time.
